(19) United States
(12) Patent Application Publication
(10) Pub. No.: US 2023/0087584 A1
(43) Pub. Date: Mar. 23, 2023

(54) RECONCILIATING PAYMENT TRANSACTIONS PERFORMED BY A PAYMENT SERVICE PROVIDER

(71) Applicant: Amazon Technologies, Inc., Seattle, WA (US)

(72) Inventor: Ayush Jaggi, Seattle, WA (US)

(21) Appl. No.: 17/471,939

(22) Filed: Sep. 10, 2021

(51) Int. Cl. G06Q 20/32; G06Q 20/40; G06Q 20/06; G06Q 20/10

(52) U.S. Cl. CPC G06Q 20/3278; G06Q 20/10; G06Q 20/065; G06Q 20/405

(57) ABSTRACT

Technologies are disclosed for reconciliating payment transactions performed by a payment service provider. Instead of reconciling the payment transactions in a serial manner, a reconciliation service performs payment reconciliation in a distributed manner among different reconciliation processes within a service provider network such that payment reconciliation for payment transactions can be distributed between a number of different reconciliation processes. Remittance data received from a payment service provider and deposit data received by a financial institution may be used by the reconciliation processes to perform payment reconciliation. The payment reconciliation processes may be performed within a selected geographic region in order to satisfy different reconciliation requirements/regulations.

### BACKGROUND

Many online merchants use payment services to process payment transactions on their behalf. Generally, a payment service allows a merchant to accept online payments, such as debit or credit card payments without having to go through a bank. A payment service may accept funds from customers via various payment instruments, aggregate customer funds and settle/transfer them to the online merchants within a prescribed time-period. For example, a payment service may receive payments associated with a merchant on one day and then report the payment information to the merchant on the next day. After receiving the payment information from the payment service, the merchant may attempt to perform payment reconciliation that reconciles expected payments with received payments. When there are a large number of transactions, payment reconciliation can take many days to perform. This may cause non-compliance with regulatory guidelines that may require payment reconciliation to be completed in a shorter period of time.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a software and network architecture diagram showing aspects of the configuration and utilization of a reconciliation system for reconciliating payment transactions performed by a payment service provider.

FIG. 2 is a software and network architecture diagram showing aspects of a reconciliation system that utilizes various services associated with a service provider to facilitate reconciliating payment transactions performed by a payment service provider.

FIG. 3 is a flow diagram showing an illustrative routine for reconciliating payment transactions performed by a payment service provider.

FIG. 4 is a flow diagram showing an illustrative routine for reconciliating payment transactions performed by a payment service provider using different reconciliation processes.

FIG. 5 is a flow diagram showing an illustrative routine for monitoring reconciliation processes.

FIG. 6 is a system and network diagram that shows an illustrative operating environment including several data centers that can be configured to implement aspects of the functionality described herein.

FIG. 7 is a computing system diagram illustrating a configuration for a data center that can be utilized to implement aspects of the technologies disclosed herein.

FIG. 8 is a computer architecture diagram showing an illustrative computer hardware architecture for implementing a computing device that can be utilized to implement aspects of the various technologies presented herein.

### DETAILED DESCRIPTION

The following detailed description is directed to technologies for reconciliating payment transactions performed by a payment service provider. In some configurations, a reconciliation service executing within a service provider network is used to perform payment reconciliation associated with payment transactions made to a third-party payment service provider. The payment service provider collects payments on behalf of an entity, such as an online merchant that is associated with the service provider network. “Payment reconciliation” refers to a process that compares different records to check that recorded payment transactions are correct. Reconciliation may also confirm that accounts in a general ledger are consistent, accurate, and complete and is used to detect any mistakes, discrepancies, or fraud in accounting books. Generally, payment reconciliation determines that for each transaction there is a received payment from a payment service provider, and that funds deposited in an account are consistent with the payment transactions reconciled.

As used herein, a “payment transaction” (which may also be referred to as a “transaction”) is an electronic transaction to pay for good(s) and/or service(s). In some examples, the payment transactions are for goods or services associated with an online merchant affiliated with a service provider network and are handled by a third-party payment service provider. A “payment service provider” is a third-party entity that assists online merchants to accept a wide range of online payment methods, such as online banking, credit cards, debit cards, e-wallets, cash cards, and the like.

Prior to the techniques described herein, online merchants relied on accounting ledger(s) for payment reconciliation by payment service providers. Stated another way, this means that on online merchant had to rely on accounting books and accounting personnel, which could take many days (depending on the volume of payments) to reconcile payment transactions made to the payment service provider for a single day. While it may have been acceptable in the past for payment reconciliation to take days/weeks, today payment reconciliation must be completed much more quickly (e.g., less than a day, hours, minutes, ...). In some cases, a time delay to perform payment reconciliation can result in breaking compliance timelines and/or other regulations made by various countries. In order to meet these new payment reconciliation requirements new techniques had to be developed.

Using techniques described herein, payment reconciliation can be performed in a distributed and parallel manner among different reconciliation processes within a service provider network such that payment reconciliation for payment transactions can be distributed between different reconciliation processes. For instance, a payment reconciliation process may be executed for each individual transaction identified within remittance data (e.g., 10 million reconciliation processes for 10 million payment transactions). In other examples, a payment reconciliation process may be executed for several transactions (e.g., 5 million reconciliation processes for 10 million payment transactions).

Compared to prior techniques, distributing payment reconciliation among different computer processes requires less time, uses computing resources more efficiently, and is much more cost effective. In many cases, reconciliation of the payment transactions may be performed in minutes without human interaction as compared to days/weeks that required accountants and/or other personnel to perform payment reconciliation for a single day of payment transactions. Further, instead of relying on costly supercomputing resources, the reconciliation processes may be distributed among standard computing resources provided by a service provider network.

As an example, using techniques described herein, payment reconciliation for millions of payment transactions for a single day can be performed in parallel much faster (e.g., within minutes) as compared to the traditional serially performed reconciliation techniques that may require days/weeks to perform. In addition to faster reconciliation of the payment transactions, the location of where the payment reconciliation is performed may be controlled. For instance, the payment reconciliation processes may be performed using computing resources within a selected geographic region/location in order to satisfy different reconciliation requirements/regulations. In some configurations, payment reconciliation may be configured to be performed by processes that execute in a data center of a service provider network that is in the same country/region where the payment transactions occurred. In this way, data associated with the payment transactions remains within the country/region in which the payment transaction was made.

Still further, the computing resources of a service provider network are more efficiently used since individual computing resources may be released more quickly after performing payment reconciliation for one or more payment transactions. This reduces the amount of computing resources that are allocated or reserved for payment processing operations, and as such, do not sit idle or unused. As such, the payment reconciliation techniques described herein help to enable business entities worldwide that accept electronic payments to effectively reconcile their payment service provider payments and be compliant with various government regulations.

As briefly discussed above, online merchants may use payment service provider(s) to accept funds received from customers via various payment instruments for transactions, aggregate customer funds, and settle the transactions within a specified time-period. In some examples, payment service providers may be subject to guidelines/regulations that impact the way the payment service providers and the online merchants operate. For instance, merchants may be restricted in how they receive payment for an online transaction. As an example, payments for transactions with an online marketplace may need to be a separate entity from the online marketplace. Online merchants and/or online marketplaces may also be restricted in storing customer payment information (e.g., credit/debit card numbers, ...), and online merchant systems may be restricted from having access to servers where the payments data is stored by a payment service provider/aggregator. As another example, regulations may require a payment service to operate a single escrow account and own settlements to merchants. The regulations may also specify that payments data is to be stored only in a specific country/region.

According to some techniques, a reconciliation system associated with a service provider network includes a reconciliation service that performs operations relating to payment reconciliation for transactions that involve a payment service provider that is external to the service provider network. In some examples, remittance data provided by a payment service provider is used by the reconciliation service to reconcile the payment transactions made using the payment service provider. The remittance data includes information associated with the payment transactions processed by the payment service provider. For example, the remittance data may include information such as but not limited to, a total number of payment transactions, a total cash value of the payment transactions, as well as a cash value associated with each individual payment transaction.

Instead of reconciling the payment transactions in a serial manner, the reconciliation service may start reconciliation processes that execute within a service provider network at the same time as other reconciliation processes. For instance, the reconciliation service may start different reconciliation processes to process different portions of transactions identified within the remittance data. The size of the portions that are reconciled by a reconciliation process may be a single transaction, 10 transactions, 1000 transactions, or any other number of transactions. In this way, the reconciliation of the transactions may be completed more efficiently without the use of as many resources as compared to prior techniques.

The reconciliation service may also receive deposit data from a bank, or some other source. In some configurations, a bank provides deposit data that identifies that a deposit of funds was made to an account associated with a merchant. According to some examples, the deposit data is provided according to a Bank Administration Institute (BAI) 2 format that is widely used by banks and other financial institutions. Other formats may also be used. Generally, a BAI2 format is a standardized set of codes in a text format. The deposit data may contain data such as but not limited to accounts payable (AP) payments and receipts (remittance status). In some examples, the reconciliation service uses the remittance data provided by the payment service provider, the deposit data provided by a bank or some other financial institution, and transaction data generated by the service provider network and/or the merchant to perform payment reconciliation.

When there is a problem reconciling a payment transaction, the reconciliation process attempting to reconcile the transaction may be configured to perform different operations depending on the problem. As an example, if deposit data has not been received for the transaction, the reconciliation process may pause operations until deposit data associated with the transaction is received. As another example, if the remittance data provided by a payment service provider does not indicate a transaction that is included in the merchant’s transactions, the reconciliation process may provide a notification of the discrepancy to an authorized user, transmit a message to the payment service provider indicating the discrepancy, and/or the like. Instead of problems with reconciling a transaction stopping the reconciliation of other transactions, other reconciliation processes may continue to reconcile other transactions. In this way, payment reconciliation may be performed faster as compared to traditional reconciliation methods.

In some examples, the reconciliation service, or some other service of the service provider network, monitors for problems during the reconciliation of the payment transactions (e.g., network connectivity, failed process, ...). When a problem is detected, the reconciliation service attempts to resolve the problem in an automated or partially automated manner without user interaction. For example, the reconciliation service may, without user input, automatically restart the reconciliation process and continue the reconciliation of data from the point in time the problem was detected. In case of problems that cannot be automatically resolved, the reconciliation service may present detailed diagnostic information to an authorized user.

After performing reconciliation, each of the reconciliation processes may generate a reconciliation report. The reconciliation report may include information, such as but not limited to what transactions may not have been reconciled and any problems encountered as well as information about reconciled transactions. The data in the reconciliation reports may be used by accountants for further accounting activities and/or by some other authorized user.

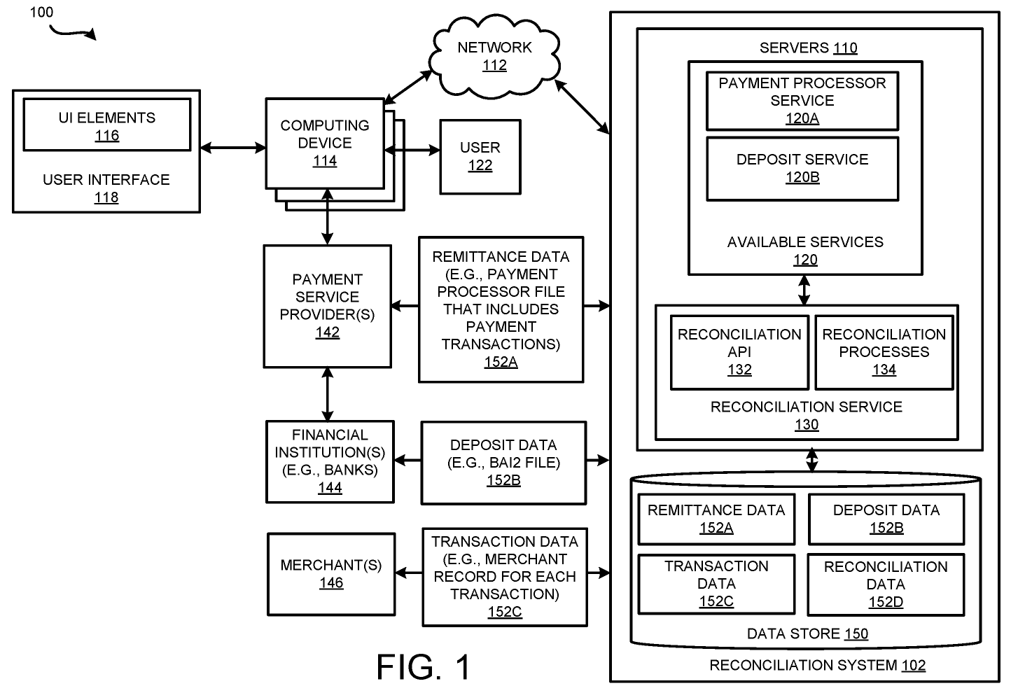

As an example, a payment service provider may perform tens of thousands, or millions, of payment transactions for an online merchant in a single day. Instead of having to step through each of the payment transactions serially, the reconciliation service may split the transactions into thousands, tens of thousands, millions of reconciliation processes that may be performed at least partly in parallel. In this way, each reconciliation process may perform payment reconciliation for a smaller number of payment transactions and execute independently of the other reconciliation processes thereby saving time and freeing up computing resources for use by some other process. Additional details regarding the various components and processes described briefly above for reconciliating payment transactions will be presented below with regard to FIGS. 1-8.

It should be appreciated that the subject matter presented herein can be implemented as a computer process, a computer-controlled apparatus, a computing system, or an article of manufacture, such as a computer-readable storage medium. While the subject matter described herein is presented in the general context of program modules that execute on one or more computing devices, those skilled in the art will recognize that other implementations can be performed in combination with other types of program modules. Generally, program modules include routines, programs, components, data structures, and other types of structures that perform particular tasks or implement particular abstract data types.

Those skilled in the art will also appreciate that aspects of the subject matter described herein can be practiced on or in conjunction with other computer system configurations beyond those described herein, including multiprocessor systems, microprocessor-based or programmable consumer electronics, minicomputers, mainframe computers, handheld computers, personal digital assistants, e-readers, mobile telephone devices, tablet computing devices, special-purposed hardware devices, network appliances, and the like. The configurations described herein can also be practiced in distributed computing environments, where tasks can be performed by remote computing devices that are linked through a communications network. In a distributed computing environment, program modules can be located in both local and remote storage devices.

In the following detailed description, references are made to the accompanying drawings that form a part hereof, and that show, by way of illustration, specific configurations or examples. The drawings herein are not drawn to scale. Like numerals represent like elements throughout the several figures (which might be referred to herein as a “FIG.” or “FIGS.”).

FIG. 1 is a software and network architecture diagram showing aspects of the configuration and utilization a reconciliation system 102 for reconciliating payment transactions performed by a payment service provider. It is to be appreciated that the environment 100 is merely illustrative and that the various configurations disclosed herein can be utilized in many different types of computing environments.

To provide the reconciliation service 130 and the other functionality disclosed herein, the reconciliation system 102 may include one or more servers 110. The servers 110 can execute software components to provide the services described herein, including reconciliation service 130 functionality and different services 120 provided by a service provider and/or some other entity. The software components can execute on a single server 110 or in parallel across multiple servers in the reconciliation system 102. In addition, a software component can consist of subcomponents executing on different servers 110 or other computing devices in the reconciliation system 102. Various components can be implemented as software, hardware, or any combination of the two. In this regard, it is to be appreciated that the reconciliation system 102 shown in FIG. 1 has been simplified for discussion purposes and that many additional software and hardware components can be utilized.

A user 122 of the reconciliation system 102 can utilize the reconciliation service 130, via a computing device 114 or some other input device, to access the reconciliation system 102 through a network 112. According to some configurations, the computing device 114 may be configured to understand natural language voice commands and complete tasks for the user, such as tasks related to reconciliation as described herein. As illustrated, a user may interact with the reconciliation service 130 through a user interface 118. In some examples, the user 122 is a customer of a service provider network.

The computing device 114 may be one or more devices, such as but not limited to a smart phone, a smart watch, a personal computer (“PC”), desktop workstation, laptop computer, tablet computer, notebook computer, personal digital assistants (“PDA”), electronic-book reader, game console, set-top box, consumer electronics device, server computer, a telephone, a telephone conferencing device, video conferencing device, or any other type of computing device capable of connecting to the network 112 and communicating with the reconciliation system 102. In other configurations, the computing device 114 may be configured to communicate with one or more other devices to receive commands from users and/or perform processing related to functionality of the reconciliation system 102.

As illustrated, the computing device 114, or some other device or component, may couple with a reconciliation system 102 over a network 112. The network 112 may represent an array or wired networks, wireless networks (e.g., Wi-Fi), or combinations thereof. The reconciliation system 102 may generally refer to a network-accessible platform implemented as a computing infrastructure of processors, storage, software, data access, and so forth that is maintained and accessible via the network 112, such as the Internet. These services may not require end-user knowledge of the physical location and configuration of the system that delivers the services. Common expressions associated with these remote services, such as the reconciliation system 102, include “on-demand computing”, “software as a service (SaaS)”, “platform computing”, “network accessible platform”, and so forth.

As illustrated, the reconciliation system 102 may comprise one or more network-accessible resources, such as servers 110. These resources comprise one or more processors and computer-readable storage media executable on the processors. In some configurations, the users 122 may be identified and/or authenticated before interacting with the computing device 114 that is associated with the reconciliation system 102.

The network 112 can be a local-area network (“LAN”), a wide-area network (“WAN”), the Internet, or any other networking topology known in the art that connects the user devices to the reconciliation system 102. The user 122 can use an application (not shown) executing on computing device 114 that provides user interface 118 to access and utilize the reconciliation service functionality provided by the servers 110. In some examples, the application is a web browser application (not shown), such as the Amazon® Silk® web browser, or some other web browser. Generally, a web browser application exchanges data with the servers 110 in the reconciliation system 102 using the hypertext transfer protocol (“HTTP”) over the network 112. The application might also be a stand-alone client application configured for communicating with the servers 110.

The application can also utilize any number of communication methods known in the art to communicate with the reconciliation system 102 and/or the servers 110 across the network 112, including remote procedure calls, SOAP-based web services, remote file access, proprietary client-server architectures, and the like. According to some configurations, the application may provide a user interface 118 that can be utilized by the user 122 to configure settings associated with the reconciliation service 130 and/or the computing device 114. Typically, a user 122 interacts with the computing device 114 using user interface 118.

As discussed above, a reconciliation service 130 is configured to perform reconciliation of payment transactions performed by a payment service provider 142. In some examples, a user, such as user 122, may access reconciliation data 152D to obtain information about a reconciliation of one or more payment transactions, or for some other purpose. According to some configurations, the reconciliation service 130 is coupled to a payment service provider(s) 142, to financial institution(s) 144, and to one or more merchant(s) 146.

As illustrated, a reconciliation service 130 executing within a service provider network is used to perform payment reconciliation associated with payment transactions made to third-party payment service provider(s) 142 that collects payments on behalf of an entity, such as an online merchant 146 that is associated with the service provider network. In some examples, the online merchant(s) 146 may sell goods/services on a marketplace hosted by the service provider network. The online merchant(s) 146 may be third-party online merchant(s) 146 and/or the service provider itself.

Instead of performing reconciliation of payment transactions serially, the reconciliation service 130 can execute multiple reconciliation processes 134 in parallel to perform reconciliation of one or more payment transactions identified from the remittance data 152A. For instance, the reconciliation service 130 may start different reconciliation processes to process different portions of transactions identified within the remittance data. The size of the portions may be a single transaction, 10 transactions, 1000 transactions, or any other number of transactions.

In some configurations, a fork-join framework may be used to perform the reconciliation in parallel. A fork-join framework divides a large task into smaller tasks and then joins the results of the smaller tasks. According to some examples, a fork-join framework is configured to recursively divide the payment reconciliation of a large number of payment transactions (e.g., thousands, millions) into the execution of a large number of parallel reconciliation processes (e.g., thousands, millions). The results of each reconciliation process are then joined/merged to produce results of each of the different reconciliation processes. In some examples, the fork-join model is configured to execute a separate process for each payment transaction identified from the remittance data 152A. In other examples, the fork-join may result in more than one transaction being associated with an individual reconciliation process.

According to some configurations, the reconciliation service 130 determines computing resources (e.g., servers, processors, ...) that are available to perform reconciliation processes. For instance, the reconciliation service 130 may query one or more computing devices/services to determine how many reconciliation processors may be executed on that computing device. Some computing resources may be able to execute millions of reconciliation processes, whereas other computing resources may not be able to execute any reconciliation process.

Performing reconciliation in a distributed manner among different reconciliation processes within a service provider network requires less time, utilizes computing resources more efficiently, and is much more cost effective as compared to prior techniques. Using prior techniques, the reconciliation of payment transactions may take longer than allowed by regulations thereby exposing a service provider using a payment service provider to be non-compliant.

According to some configurations, the reconciliation service 130 may cause the reconciliation processes 134 to execute within one or more designated geographical regions (e.g., a specific country, region, city, ...). For instance, the payment reconciliation processes 134 may be performed within data center of a selected geographic region in order to satisfy reconciliation requirements/regulations. In some configurations, the reconciliation service 130 executes the reconciliation processes within the same country in which the payment service provider(s) 142, financial institution(s) 144, and the customers associated with each of the payment transactions are located. In this way, data associated with the payment transactions remains within the country/region in which the payment transaction was made. As such, the payment reconciliation techniques described herein help to enable business entities worldwide which accept electronic payments to effectively reconcile their payment service provider payments and be compliant with various government regulations.

As briefly discussed above, remittance data 152A provided by a payment service provider 142 is used by the reconciliation service 130 to reconcile the payment transactions made using the payment service provider 152A. The remittance data 152A includes information associated with the payment transactions processed by the payment service provider. For example, the remittance data 152a may include information such as but not limited to, a total number of payment transactions, a total cash value of the payment transactions, as well as a cash value associated with each individual payment transaction. In some examples, the remittance data 152A is stored in a data store 150 of the service provider network.

The reconciliation service 130 may also receive deposit data 152B from a financial institution(s) 144, such as a bank. In some configurations, a financial institution 144 provides deposit data 152 that identifies that a deposit of funds was made to an account associated with the service provider network. According to some examples, the deposit data 152B is provided according to BAI2 format. In some examples, the reconciliation service 130 uses the remittance data 152A provided by a payment service provider 142, the deposit data 152B provided by a financial institution, 144 and transaction data 152C generated by the service provider network and/or the merchant to perform payment reconciliation. The transaction data 152C is a record of a transaction recorded by the service provider network that uses a payment service provider 142 to obtain the payment for a good or service.

In some configurations, the reconciliation service, 130 or some other service of the service provider network, monitors for problems during the reconciliation of the payment transactions (e.g., network connectivity, failed process, ...). When a problem is detected, the reconciliation service 130 attempts to resolve the problem without user interaction. For example, the reconciliation service may restart the reconciliation process and continue the reconciliation of data from the point in time the problem was detected. In case of problems that cannot be automatically resolved, the reconciliation service may present detailed diagnostic information to an authorized user.

When there is a problem reconciling a payment transaction, the reconciliation process 134 attempting to reconcile the transaction may be configured to perform different operations depending on the problem. As an example, if deposit data 152B has not been received for the transaction, the reconciliation process 134 may pause operations until deposit data associated with the transaction is received. As another example, if the remittance data 152A provided by a payment service provider does not indicate a transaction that is included in the transaction data 152C may provide a notification of the discrepancy to an authorized user, transmit a message to the payment service provider indicating the discrepancy, and/or the like. Instead of problems with reconciling a transaction stopping the reconciliation of other transactions, other reconciliation processes 134 may continue to reconcile other transactions. In this way, payment reconciliation may be performed faster as compared to traditional reconciliation methods.

After performing reconciliation, a reconciliation process 134 may generate a reconciliation report. The reconciliation report may include information, such as but not limited to what transactions may not have been reconciled and any problems encountered as well as information about reconciled transactions. The data in the reconciliation reports may be used by accountants for further accounting activities and/or by some other authorized user

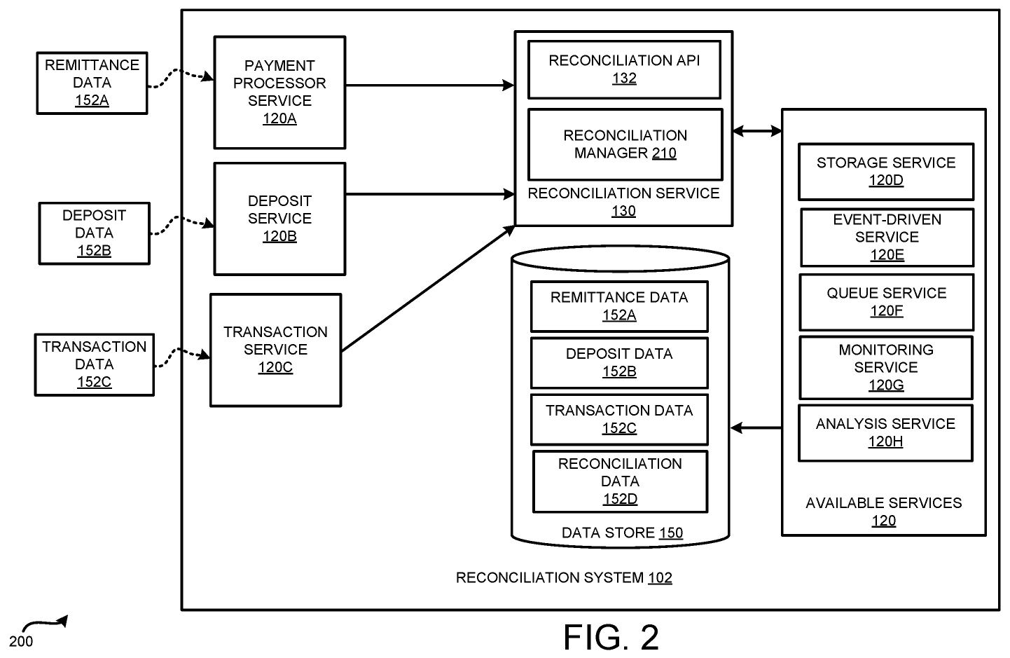

According to some examples, an occurrence of one or more events triggers the reconciliation of the payment transactions. For instance, in response to the occurrence of an event the reconciliation service 130 automatically begins to perform the reconciliation. For instance, as discussed in more detail in FIG. 2, receiving remittance data 152A, receiving deposit data 152B, the time being a specified time to perform the reconciliation, may trigger the start of the reconciliation of the payment transactions.

In other examples, the user 122 may begin reconciliation by selecting a few options from a user interface, such as from user interface 118. According to some configurations, the reconciliation service 130 provides to a user computing device 114 reconciliation data 152D within a user interface 118 (e.g., a “GUI”). In yet other examples, the reconciliation service 130 may periodically start a reconciliation process.

According to some examples, the user interface 118 includes selectable UI elements 116 that allow a user 122 to select, configure, and/or specify different data associated with the reconciliation of payment transactions. For instance, UI elements 116 may be utilized to start a reconciliation process, stop a reconciliation process, view data about a reconciliation process, view results of a reconciliation process, and the like. In some cases, the user 122 may utilize a UI element 116 to specify time(s) to begin reconciliation of the payment transactions and/or indicate some other event on which to begin reconciliation.

According to some examples, the reconciliation service 130 may expose a reconciliation Application Programming Interface (API) 132. In some configurations, functionality provided by the reconciliation service 130 may be accessed using the reconciliation API 132 that may be a Web API. The reconciliation API 132 might also be used to request data from one or more data stores such as data store 150, services 120, and/or other applications, and the like. Some exemplary APIs include but are not limited to specifying when to start a reconciliation process, stopping a reconciliation, obtaining reconciliation report data, and the like.

According to some examples, after reconciliating payment transactions, replicated account data 152D can be generated. In some configurations, the reconciliation service 130 generates one or more reconciliation reports. A reconciliation report includes data from the reconciliation data 152. The reconciliation data 152 may be stored in the data store 150, or in some other data store or memory.

In some configurations, the reconciliation service 130 may access other available services 120 to obtain data that may be used by the reconciliation service 130. For example, the reconciliation service 130 may access a payment processor service 120A, a deposit service 120B, a transaction service 120C, and/or other available services 120 (See FIG. 2 and related discussion). Additional details regarding the various processes described above with regard to FIG. 1 will be provided below with regard to FIGS. 2-7.

FIG. 2 is a software and network architecture diagram showing aspects of a reconciliation system 102 that utilizes various services 120 associated with a service provider to facilitate reconciliating payment transactions performed by a payment service provider 142. It is to be appreciated that the environment 200 is merely illustrative and that the various configurations disclosed herein can be utilized in many different types of computing environments. FIG. 2 is similar to FIG. 1 but provides more details of the reconciliation system 102.

As illustrated, reconciliation system 102 includes reconciliation service 130, payment processor service 120A, deposit service 120B, transaction service 120C, storage service 120D, event-driven service 120E, queue service 120F, monitoring service 120G, and analysis service 120H. The reconciliation service 130 may communicate with the services using one or more Application Programming Interfaces (APIs), such as reconciliation API 132 exposed by the reconciliation service 130. In some examples, each service may expose one or more APIs (not shown) that can be used by a service, or some other component or application, to access functionality and/or data provided by the service.

According to some configurations, the reconciliation service 130 utilizes a payment processor service 120A to receive remittance data 152A, a deposit service 120B to receive deposit data 152B, and a transaction service 152C to receive transaction data 152C. The reconciliation service 130 is also shown using a storage service 120D to store data associated with the reconciliation of payment transactions. In some examples, the storage service 120D is within the same geographic region/country as to where the execution of the reconciliation is performed. In the current example, the storage service 120D may be used to store the remittance data 152A, the deposit data 152B, the transaction data 152C, the reconciliation data 152D, and/or other data.

In some examples, the event-driven service 120E is configured to generate one or more notifications/messages in response to detection of events associated with payment reconciliation. For example, the event-driven service 120E may generate a notification/message when remittance data 152A is received, when deposit data 152B, when a reconciliation process 134 completes, when a reconciliation process 134 encounters a problem, when a reconciliation report is generated, and the like. In some examples, the event-driven service 120E may provide the notifications/messages to a queue service 120F for distribution to one or more services and/or authorized users. In some examples, the event-driven service 120B is a service that runs code without provisioning or managing servers (e.g., AWS® Lambda).

The queue service 120F can be a managed message queuing service that provides messaging for applications and/or services, such as reconciliation service 130. The queue service 120F helps to remove the complexity and overhead associated with managing and operating message-oriented middleware and empowers developers to focus on other tasks. As illustrated, queue service 120F is configured to store messages utilized by the reconciliation service 130 to initiate the reconciliation of the remittance data 152A, the deposit data 152B, the transaction data 152C, and/or other data (not shown). According to some examples, the queue service 120F may queue messages relating to beginning a reconciliation process, stopping a reconciliation process, problems with a reconciliation process, results from a reconciliation process, and the like

In some examples, the reconciliation service 130 monitors for problems associated with the reconciliation processes 134 (e.g., network connectivity, failed process, ...). According to some configurations, a monitoring service 120G monitors the data stores being utilized during the reconciliation process (e.g., data store 150), network connectivity, and possibly other processes during the reconciliation process. The monitoring service 120G may provide health data (not shown) related to the reconciliation process to the reconciliation manager 210, the reconciliation service 130 and/or some other computing device or component.

When a problem is detected (e.g., a process associated with the reconciliation has stopped), the reconciliation manager 210 in the reconciliation service 130 may attempt to resolve the problem without user interaction. For example, the reconciliation service 130 may restart the reconciliation process 134 and continue the reconciliation from the point in time the problem was detected, in a fully or partially automated manner, and possibly without requiring any input from a user associated with the data being replicated. As another example, the reconciliation service 130 may restart the reconciliation process from the beginning. In case of problems that cannot be automatically resolved, the reconciliation service 116 may present detailed diagnostic information to a user (e.g., using UI 140).

According to some examples, an analysis service 120H may access data associated with the reconciliation of the payment transactions to perform various accounting operations or other analysis.

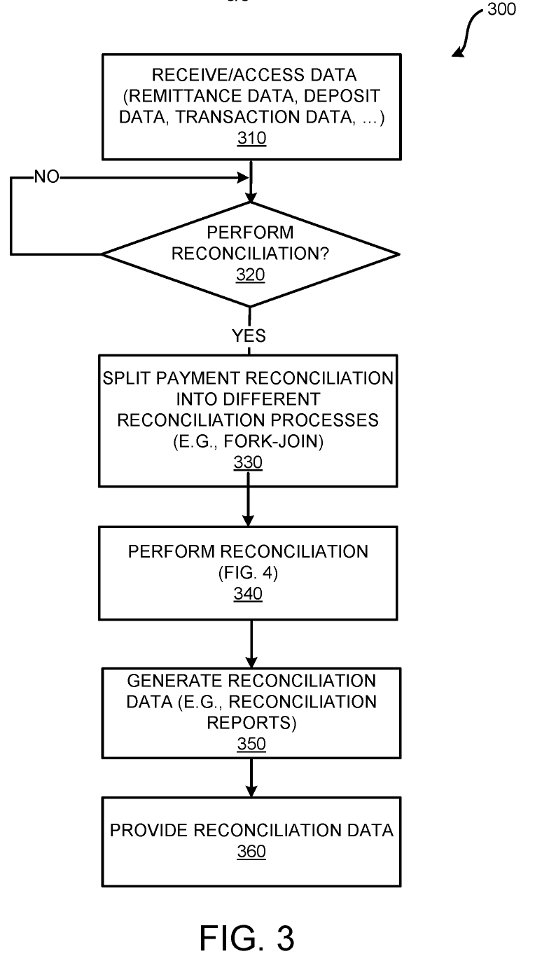

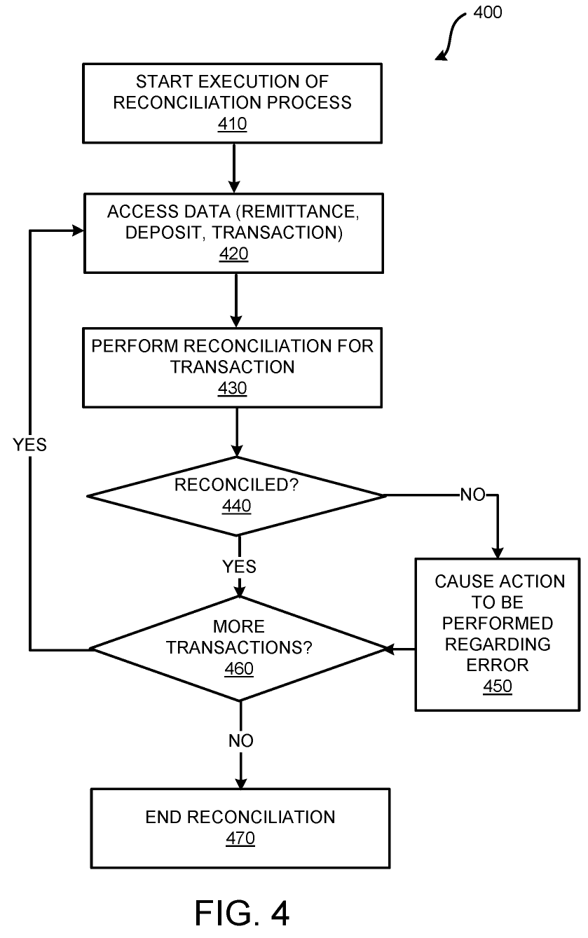

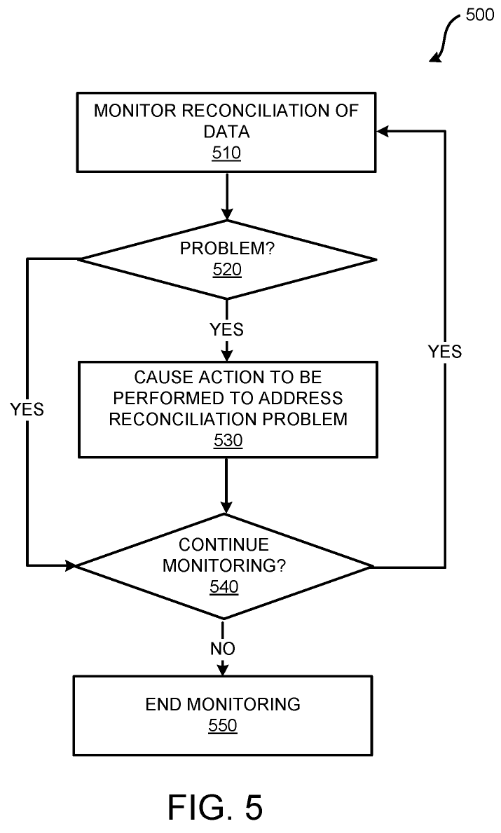

FIGS. 3-5 are flow diagrams showing illustrative routines 300, 400, and 500, for reconciliating payment transactions performed by a payment service provider, according to examples disclosed herein. It should be appreciated that the logical operations described herein with respect to FIG. 3, FIG. 4, FIG. 5, and the other FIGS., can be implemented (1) as a sequence of computer implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations can be performed than shown in the FIGS. and described herein. These operations can also be performed in parallel, or in a different order than those described herein. Some or all of these operations can also be performed by components other than those specifically identified.

FIG. 3 is a flow diagram showing an illustrative routine for reconciliating payment transactions performed by a payment service provider 142. At 310, data is received/accessed. As discussed above, the data 152 may include remittance data 152A, deposit data 152B, transaction data 152C, and/or some other data that is used to perform payment reconciliation. In some configurations, a payment service 142 provides remittance data 152A, a financial institution 144 provides deposit data 152B, and on online merchant 146 and/or a service (not shown), or some other device or component, that is part of the service provider network in which the online merchant operates may provide the transaction data 152C.

At 320, a determination is made as to whether to proceed to perform payment reconciliation. As discussed above, the determination of whether to perform payment reconciliation may be based on one or more events/conditions, such as but not limited to: a specified time (e.g., every hour), occurrence of a specified event (e.g., receipt of remittance data 152A, deposit data 152B, ...), a manual trigger, and the like. In some examples, an event-driven service 120D may provide a notification that triggers the payment reconciliation process. When payment reconciliation is to proceed, the routine flows to 330. When payment reconciliation is not to proceed, the routine may return to 320.

At 330, payment reconciliation is split into different reconciliation processes. As discussed above, instead of relying on accounting personnel to perform payment reconciliation, payment reconciliation may be performed in parallel without human intervention. In some examples, the reconciliation service 130 uses a fork-join framework to recursively divide the payment reconciliation of payment transactions into the parallel execution of a large number of parallel reconciliation processes (e.g., thousands, millions). Each reconciliation process provides results for its reconciliation of one or payment transactions and the reconciliation service 130 can join the results to produce an overall result. In some configurations, the reconciliation service 130 executes a separate reconciliation process for each payment transaction identified from the remittance data 152A. In other examples, the fork-join may result in more than one transaction being associated with an individual reconciliation process.

At 340, payment reconciliation is performed. As discussed above, the reconciliation service 130 may generate a reconciliation process 134 to perform the payment reconciliation for one or more transactions. In some examples, more than one reconciliation process may be performed at the same time. For instance, a first payment reconciliation process 134 may perform operations relating to reconciling a first set of payment transactions and a second payment reconciliation process 134 may perform operations relating to reconciling a second set of payment transactions (See FIG. 4 for more details).

At 350, reconciliation data is generated. As discussed above, reconciliation data 152D may include one or more reconciliation reports, and/or other data related to the reconciliation process. In some examples, reconciliation reports may include information about what transactions may not have been reconciled and any problems encountered as well as information about reconciled transactions. The data in the reconciliation reports may be used by accountants for further accounting activities and/or by some other authorized user.

At 360, the reconciliation data 152D may be provided. As discussed above, the reconciliation data 152D may be provided to one or more computing devices and used by authorized users, such as accountants, as well as by one or more other services.

FIG. 4 is a flow diagram showing an illustrative routine 400 for reconciliating payment transactions performed by a payment service provider using different reconciliation processes according to examples disclosed herein.

The routine 400 begins at 410, where execution of a reconciliation process 134 is started. As discussed above, the execution of a reconciliation process 134 may be started based on an occurrence of an event, or some other condition. For example, a user 122 may trigger the reconciliation of payment transactions via an interaction with a UI 118, or some other mechanism. In some configurations, the execution of a reconciliation process 134 may be started in response to receiving one or more of remittance data 152A, deposit data 152B, occurrence of a scheduled time, and the like.

At 420, the data used to perform payment reconciliation is accessed. As discussed above, the reconciliation process 134 accesses remittance data 152A, the deposit data 152B, the transaction data 152C, the reconciliation data 152D, and/or other data from a data store 150, or some other location.

At 430, the reconciliation for a first transaction is started. Many techniques may be used to perform payment reconciliation. As discussed above, in some configurations, the reconciliation service 130 attempts to determine that for each payment transaction there is a received payment, and that funds deposited in an account are consistent with the payment transactions reconciled.

At 440, a determination is made as to whether or not the transaction has been reconciled. As discussed above, a payment transaction may not be reconciled due to a variety of reasons (e.g., missing data, failure of a process, ...). When the transaction has not been reconciled the process 400 moves to 450. When the transaction has been reconciled the process 400 moves to 460.

At 450, an action is caused to be performed regarding the error. As discussed above, the reconciliation service 130 may set a state to unreconciled for the transaction and/or the reconciliation service 130 may perform some other operation, such as but not limited to pausing the reconciliation process 134 until additional remittance data 152A, deposit data 152B, and/or some other data is received.

At 460, a determination is made as to whether there are further transactions to reconciled. As discussed above, a reconciliation process 134 may be configured to process one or more payment transactions. When there are more transactions to reconcile, the process 400 returns to 420. When there are not any more transactions to reconcile, the process 400 moves to 470 where the reconciliation process 134 ends.

FIG. 5 is a flow diagram showing an illustrative process 500 for monitoring the reconciliation processes, according to examples disclosed herein. At 510, the reconciliation of the data is monitored. As discussed above, the reconciliation service 130 may monitor the reconciliation of the data to help ensure that the reconciliation is completed. For instance, the reconciliation service 130 may employ a monitoring service that identifies the health of the services being utilized to perform the reconciliation.

At 520, a decision is made as to whether a problem has been detected. As discussed above, when a problem is detected by the reconciliation manager 210, the reconciliation service 130 may attempt to address the problem at operation 530. When a problem is not detected, the process 500 flows to 540.

At 530, the reconciliation service 130 may address the problem. As discussed above, the reconciliation manager 210 may restart one or more computing resources in which a fault is detected, and/or cause one or more services to start from a particular point. In some examples, the action may be to pause the reconciliation process until further data 152 is received (e.g., deposit data, remittance data).

At operation 540, a decision is made as to continue monitoring the reconciliation process. As discussed above, when the reconciliation manager 210 determines to continue monitoring the reconciliation process, the process 500 returns to 510. When monitoring is not to continue, the process flows to 550 where the monitoring of the reconciliation process 134 is ended.

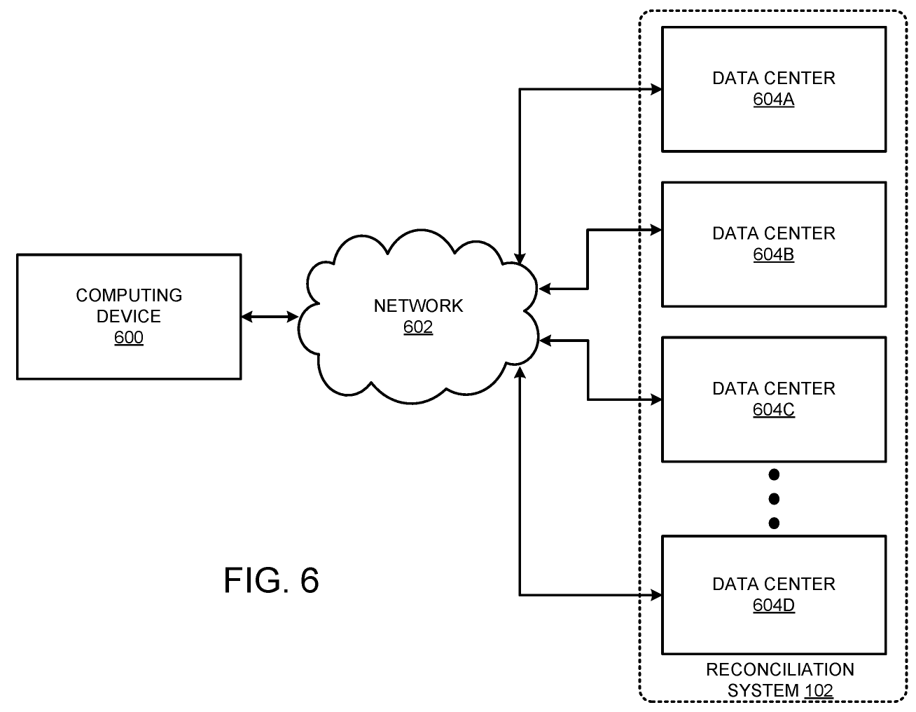

FIG. 6 is a system and network diagram that shows one illustrative operating environment for the configurations disclosed herein that includes a reconciliation system 102 that can be configured to provide the functionality described above. As discussed above, the reconciliation system 102 can execute network services that provide computing resources for implementing the functionality disclosed herein. The computing resources implemented by the reconciliation system 102 can be data processing resources, such as virtual machine (“VM”) instances, data storage resources, networking resources, data communication resources, network services, and other types of resources.

The computing resources utilized can be general-purpose or can be available in a number of specific configurations. For example, data processing resources can be available as physical computers or VM instances in a number of different configurations. The VM instances can be configured to execute applications, including web servers, servers, media servers, database servers, some or all of the network services described above, and/or other types of programs. Data storage resources can include file storage devices, block storage devices, and the like. The reconciliation system 102 can also include and utilize other types of computing resources not mentioned specifically herein.

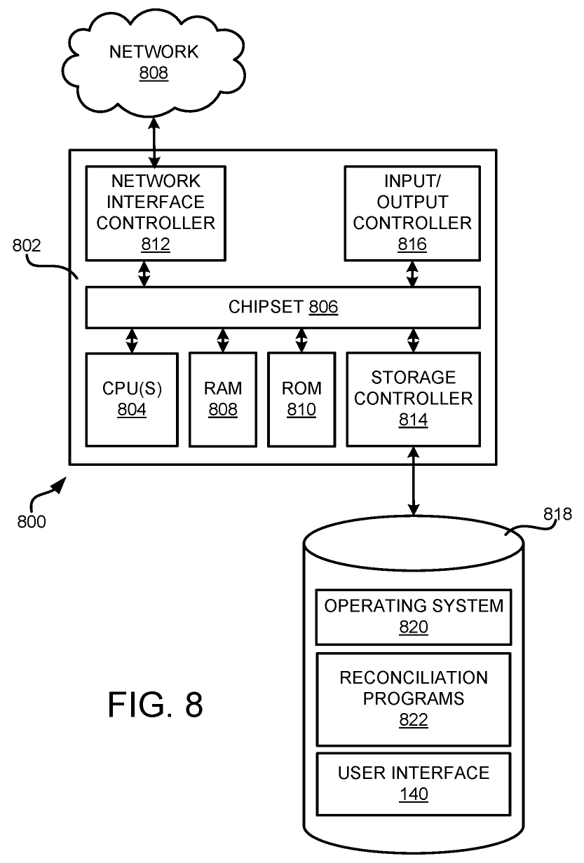

As also discussed above, the computing resources provided by the reconciliation system 102 are enabled in one implementation by one or more data centers 604A-604D (which might be referred to herein singularly as “a data center 604” or collectively as “the data centers 604”). The data centers 604 are facilities utilized to house and operate computer systems and associated components. The data centers 604 typically include redundant and backup power, communications, cooling, and security systems. The data centers 604 can also be located in geographically disparate locations. One illustrative configuration for a data center 604 that can be utilized to implement the technologies disclosed herein will be described below with regard to FIG. 8.

The users can access the services provided by the reconciliation system 102 over a network 602, which can be a wide area communication network (“WAN”), such as the Internet, an intranet or an Internet service provider (“ISP”) network or a combination of such networks. For example, and without limitation, a computing device 600 operated by a user or other user of the reconciliation system 102, such as the computing device 114, can be utilized to access the reconciliation system 102 by way of the network 602. It should be appreciated that a local-area network (“LAN”), the Internet, or any other networking topology known in the art that connects the data centers 604 to remote users and other users can be utilized. It should also be appreciated that combinations of such networks can also be utilized.

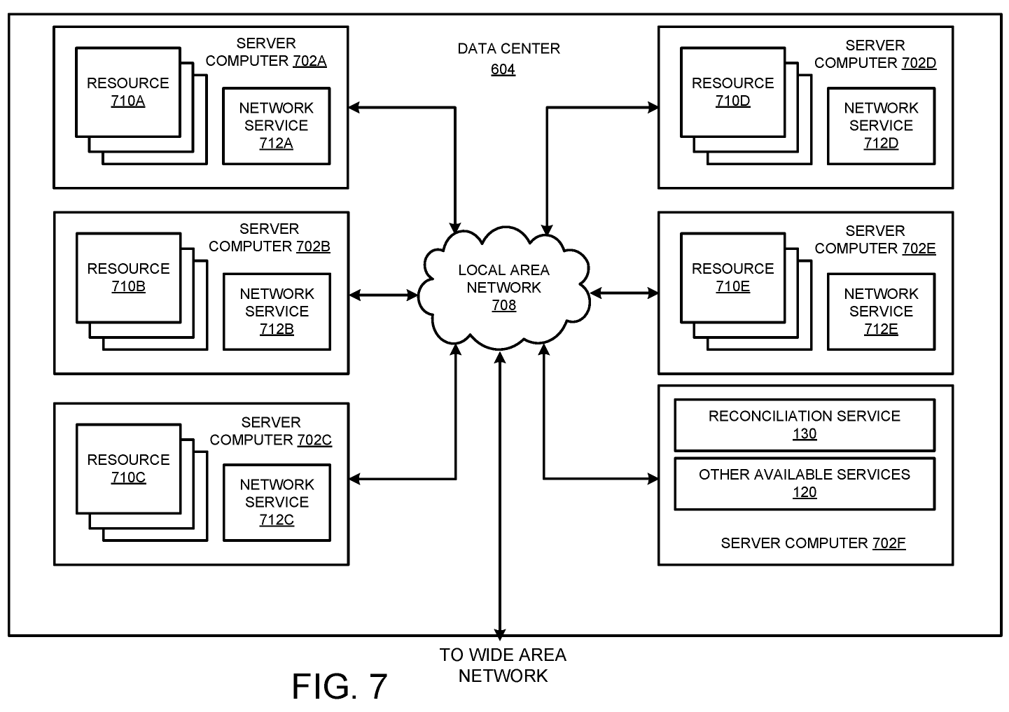

FIG. 7 is a computing system diagram that illustrates examples for a data center 604 that can be utilized to implement the reconciliation service 130, other available services 120, and the other functionality disclosed herein. The example data center 604 shown in FIG. 7 includes several server computers 702A-702F (which might be referred to herein singularly as “a server computer 702” or in the plural as “the server computers 702”).

The server computers 702 can be standard tower, rack-mount, or blade server computers configured appropriately for providing various types of computing resources 710 for implementing the functionality disclosed herein. As mentioned above, the computing resources 710 provided by the data center 604 can be data processing resources such as VM instances or hardware computing systems, data storage resources, database resources, networking resources, and others. Some of the servers 702 can also be configured to execute network services 712A-712-E, respectively, capable of instantiating, providing and/or managing the computing resources 710A-710E.

The data center 604 shown in FIG. 7 also includes a server computer 702F that can execute some or all of the software components described above. The server computer 702F can also be configured to execute other components and/or to store data for providing some or all of the functionality described herein. In this regard, it should be appreciated that components or different instances of the services can execute on many other physical or virtual servers in the data centers 604 in various configurations.

In the example data center 604 shown in FIG. 7, an appropriate LAN 708 is also utilized to interconnect the server computers 702A-702F. The LAN 708 is also connected to the network 602 illustrated in FIG. 6. It should be appreciated that the configuration of the network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between each of the data centers 604A-604D, between each of the server computers 702A-702F in each data center 604, and, potentially, between computing resources 710 in each of the data centers 604. It should be appreciated that the configuration of the data center 604 described with reference to FIG. 7 is merely illustrative and that other implementations can be utilized.

FIG. 8 shows an example computer architecture for a computer 800 capable of executing program components for implementing the functionality described above. The computer architecture shown in FIG. 8 illustrates a conventional server computer, workstation, desktop computer, laptop, tablet, network appliance, e-reader, smartphone, or other computing device, and can be utilized to execute any of the software components presented herein.

The computer 800 includes a baseboard 802, or “motherboard,” which is a printed circuit board to which a multitude of components or devices can be connected by way of a system bus or other electrical communication paths. In one illustrative configuration, one or more central processing units (“CPUs”) 804 operate in conjunction with a chipset 806. The CPUs 804 can be standard programmable processors that perform arithmetic and logical operations necessary for the operation of the computer 800.

The CPUs 804 perform operations by transitioning from one discrete, physical state to the next through the manipulation of switching elements that differentiate between and change these states. Switching elements can generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 can provide an interface to a RAM 808, used as the main memory in the computer 800. The chipset 806 can further provide an interface to a computer-readable storage medium such as a read-only memory (“ROM”) 810 or non-volatile RAM (“NVRAM”) for storing basic routines that help to startup the computer 800 and to transfer information between the various components and devices. The ROM 810 or NVRAM can also store other software components necessary for the operation of the computer 800 in accordance with the configurations described herein.

The computer 800 can operate in a networked environment using logical connections to remote computing devices and computer systems through a network, such as the network 808. The chipset 806 can include functionality for providing network connectivity through a NIC 812, such as a gigabit Ethernet adapter. The NIC 812 is capable of connecting the computer 800 to other computing devices over the network 808. It should be appreciated that multiple NICs 812 can be present in the computer 800, connecting the computer to other types of networks and remote computer systems.

The computer 800 can be connected to a mass storage device 818 that provides non-volatile storage for the computer. The mass storage device 818 can store an operating system 820, reconciliation programs 822 for providing functionality associated with the reconciliation system 102, user interface 118, and data, which have been described in greater detail herein. The mass storage device 818 can be connected to the computer 800 through a storage controller 814 connected to the chipset 806. The mass storage device 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 800 can store data on the mass storage device 818 by transforming the physical state of the physical storage units to reflect the information being stored. The specific transformation of physical state can depend on various factors, in different implementations of this description. Examples of such factors can include, but are not limited to, the technology used to implement the physical storage units, whether the mass storage device 818 is characterized as primary or secondary storage, and the like.

For example, the computer 800 can store information to the mass storage device 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 800 can further read information from the mass storage device 818 by detecting the physical states or characteristics of one or more particular locations within the physical storage units.

In addition to the mass storage device 818 described above, the computer 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 800.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the mass storage device 818 can store an operating system 820 utilized to control the operation of the computer 800. According to examples, the operating system comprises the LINUX operating system or one of its variants. According to another configuration, the operating system comprises the WINDOWS® SERVER operating system from MICROSOFT Corporation. According to further configurations, the operating system can comprise the UNIX operating system or one of its variants. It should be appreciated that other operating systems can also be utilized. The mass storage device 818 can store other system or application programs and data utilized by the computer 800.

In examples, the mass storage device 818 or other computer-readable storage media is encoded with computer-executable instructions which, when loaded into the computer 800, transform the computer from a general-purpose computing system into a special-purpose computer capable of implementing the configurations described herein. These computer-executable instructions transform the computer 800 by specifying how the CPUs 804 transition between states, as described above. According to examples, the computer 800 has access to computer-readable storage media storing computer-executable instructions which, when executed by the computer 800, perform the various processes described above with regard to FIGS. 1-8. The computer 800 can also include computer-readable storage media for performing any of the other computer-implemented operations described herein.

The computer 800 can also include one or more input/output controllers 816 for receiving and processing input from a number of input devices, such as a keyboard, a mouse, a touchpad, a touch screen, an electronic stylus, or other type of input device. Similarly, an input/output controller 816 can provide output to a display, such as a computer monitor, a flat-panel display, a digital projector, a printer, or other type of output device. It will be appreciated that the computer 800 might not include all of the components shown in FIG. 8, can include other components that are not explicitly shown in FIG. 8, or can utilize an architecture completely different than that shown in FIG. 8.

Based on the foregoing, it should be appreciated that technologies for reconciliating payment transactions performed by a payment service provider have been described herein. Moreover, although the subject matter presented herein has been described in language specific to computer structural features, methodological acts, and computer readable media, it is to be understood that the invention defined in the appended claims is not necessarily limited to the specific features, acts, or media described herein. Rather, the specific features, acts, and media are disclosed as example forms of implementing the claims.

The subject matter described above is provided by way of illustration only and should not be construed as limiting. Furthermore, the claimed subject matter is not limited to implementations that solve any or all disadvantages noted in any part of this disclosure. Various modifications and changes can be made to the subject matter described herein without following the example configurations and applications illustrated and described, and without departing from the true spirit and scope of the present invention, which is set forth in the following claims.

What is claimed is:

1. A system comprising:
one or more processors; and
a non-transitory computer-readable storage medium having instructions stored thereupon which, when executed by the one or more processors, cause the system to:
establish a first communication link between a payment processor service of a service provider network and a payment service provider that is external to the service provider network;
receive, via the first communication link, remittance data from the payment service provider, wherein the remittance data identifies payments for transactions made by customers of the service provider network using the payment service provider;
establish a second communication link between a deposit service of the service provider network and a bank network that is external to the service provider network;
receive, via the second communication link, deposit data from the bank network, wherein the deposit data indicates a deposit into an account of the service provider network;
access, from a storage service of the service provider network, transaction data that identifies records of the transactions made by the customers for goods or services associated with online merchants affiliated with the service provider network, wherein the transaction data is recorded by the service provider network;
at least in part on an occurrence of a reconciliation event, initiate, via a reconciliation service of the service provider network, parallel execution of payment reconciliation processes on computers of the service provider network to reconcile transactions identified from the remittance data, wherein each of payment reconciliation processes are assigned one or more of the transactions to reconciliate;
receive, from each of the payment reconciliation processes, reconciliation data that identifies a state of reconciliation for each of the one or more of the transactions;
generate, via the reconciliation service, a reconciliation report that indicates a state of reconciliation for each of the transactions; and
provide access to the reconciliation report.

2. The system of claim 1, including further instructions to cause the system to select the computers of the service provider network to execute the payment reconciliation processes based, at least in part, on a determination that the computers are located within a same country of the service provider network.

3. The system of claim 1, including further instructions to cause the system to identify the occurrence of the reconciliation event, wherein the reconciliation event is at least one of an expiration of a period of time, a first indication of receiving the remittance data received from an event-driven service within the service provider network, or a second indication of receiving the deposit data received from the event-driven service within the service provider network.

4. The system of claim 1, including further instructions to cause the system to:
monitor, via a monitoring service of the service provider network, the payment reconciliation processes, wherein the monitoring includes monitoring at least one of a network connectivity error or a failed process;
determine that a problem has occurred with at least one of the payment reconciliation processes; and
cause an action to be performed within the service provider network to address the problem.

5. A computer-implemented method comprising:
establishing, via one or more computers of a service provider network, one or more communication links with a payment service provider that is external to a service provider network;
receiving, via the one or more communication links, remittance data that identifies transactions paid for by customers of the service provider network using the payment service provider;
initiating, at least partly in response to receiving the remittance data, parallel execution of payment reconciliation processes on the one or more computers of the service provider network to reconcile transactions identified from the remittance data, wherein individual ones of the payment reconciliation processes are assigned one or more of the transactions to reconciliate;
generating, via the one or more computers of the service provider network, reconciliation data for the payment reconciliation processes; and
causing at least a portion of the reconciliation data to be made available.

6. The computer-implemented method of claim 5, further comprising selecting the one or more computers of the service provider network to use to execute the payment reconciliation process based, at least in part, on a determination that the one or more computers are located within a same geographical region of the service provider network.

7. The computer-implemented method of claim 5, further comprising identifying a reconciliation event that indicates to begin the parallel execution of payment reconciliation processes, wherein the reconciliation event is at least one of an expiration of a period of time, a first indication of receiving the remittance data received from an event-driven service within the service provider network, or a second indication of receiving deposit data received from the event-driven service within the service provider network.

8. The computer-implemented method of claim 5, further comprising:
monitoring, via a monitoring service of the service provider network, the parallel execution of the payment reconciliation processes, wherein the monitoring includes monitoring at least one of a network connectivity error or a failed process;
determining that a problem has occurred with at least one of payment reconciliation processes; and
causing an action to be performed within the service provider network to address the problem, wherein the action to address the problem includes adjusting one or more computing resources of the service provider network.

9. The computer-implemented method of claim 8, further comprising using a fork and join framework to divide the transactions between the payment reconciliation processes for parallel execution.

10. The computer-implemented method of claim 5, further comprising providing an application programming interface (API) that exposes functionality for payment reconciliation.

11. The computer-implemented method of claim 5, further comprising:
accessing, from a storage service of the service provider network, transaction data that identifies transactions recorded by the service provider network, wherein the transactions are made by the customers of the service provider network and are for goods or services associated with online merchants affiliated with the service provider network;
storing, via a storage service of the service provider network, the remittance data; and
storing, via the storage service of the service provider network, deposit data.

12. The computer-implemented method of claim 5, wherein the parallel execution of the payment reconciliation processes comprises:
attempting to reconcile each transaction of the transactions based at least in part on the remittance data, deposit data, and transaction data that identifies transactions recorded by the service provider network; and
associating each transaction with a state selected from at least reconciled and unreconciled based at least in part on the attempting to reconcile each transaction.

13. The computer-implemented method of claim 5, further comprising generating one or more reconciliation reports that indicate first transactions that are reconciled and second transactions that are unreconciled.

14. A system, comprising:
one or more processors; and
a non-transitory computer-readable storage medium having instructions stored thereupon which, when executed by the one or more processors, cause the system to:
establishing, via one or more computers of a service provider network, a communication link with a payment service provider that is external to a service provider network;
receiving, via the one or more communication links, remittance data received from the payment service provider, wherein the remittance data identifies transactions paid for by customers of the service provider network using the payment service provider;
access, from a storage service of the service provider network, transaction data that identifies transactions recorded by the service provider network, wherein the transactions are for goods or services associated with online merchants affiliated with the service provider network;
initiating, at least partly in response to receiving the remittance data, parallel execution of payment reconciliation processes on the one or more computers of the service provider network to reconcile transactions identified from the remittance data, wherein each of payment reconciliation processes are assigned one or more of the transactions to reconciliate;
generating, via the one or more computers of the service provider network, reconciliation data for the payment reconciliation processes; and
causing at least a portion of the reconciliation data to be made available.

15. The system of claim 14, including further instructions to cause the system to select the one or more computers to execute the payment reconciliation processes based, at least in part, on a determination that the one or more computers are located within a same geographical region of the service provider network.

16. The system of claim 14, including further instructions to cause the system to identify a reconciliation event that indicates to begin the execution of the payment reconciliation processes, wherein the reconciliation event is at least one of an expiration of a period of time or a first indication of a receipt of the data received from an event-driven service within the service provider network.

17. The system of claim 14, including further instructions to cause the system to:
monitor, via a monitoring service of the service provider network, the parallel execution of the payment reconciliation processes, wherein the monitoring includes monitoring at least one of a network connectivity error or a failed process;
determine that a problem has occurred with at least one of the payment reconciliation processes; and
cause an action to be performed within the service provider network to address the problem.

18. The system of claim 17, wherein causing the action to be performed within the service provider network to address the problem includes adjusting one or more computing resources of the service provider network.

19. The system of claim 14, wherein the parallel execution of the payment reconciliation processes comprises:
attempting to reconcile each transaction of the transactions; and
associating each transaction with a state selected from at least reconciled and unreconciled based at least in part on the attempting to reconcile each transaction.

20. The system of claim 14, including further instructions to cause the system to generate one or more reconciliation reports that indicate first transactions that are reconciled and second transactions that are unreconciled.
